(19) United States
(12) Patent Application Publication
(10) Pub. No.: US 2007/0100008 A1
(43) Pub. Date: May 3, 2007

(54) Process for preparing open-cell microcellular polystyrene foam and open-cell microcellular polystyrene foam prepared therefrom

(75) Inventors: Mu-Li Chang, Chu-Tung (TW); Pen-Chang Tseng, Chu-Tung (TW); Chih-Chen Chang, Chu-Tung (TW)

Correspondence Address: BIRCH STEWART KOLASCH & BIRCH, PO BOX 747, FALLS CHURCH, VA, 22040-0747, US

(73) Assignee: Industrial Technology Research Institute

(21) Appl. No.: 11/431,621

(22) Filed: May 11, 2006

(30) Foreign Application Priority Data
Oct. 31, 2005 (TW) 94138015

(51) Int. Cl. C08J 9/00

(52) U.S. Cl. 521/79

(57) ABSTRACT

The present invention relates to a process for preparing open-cell microcellular polystyrene foam by adding suitable polyamide as nucleating agent into the process to produce polystyrene foam having microcellular open-cell. The process comprises the steps of blending polystyrene and a polyamide polymer to give a homogeneous mixture, adding a foaming agent into the mixture and blending to give a polymer foaming solution, and finally extruding and foaming the polymer foaming solution in an extruder. The present invention also relates to the open-cell microcellular polystyrene foam prepared by the process.

### FIELD OF THE INVENTION

The present invention relates to a process for preparing open-cell microcellular foam and the prepared foam, particularly to a process for preparing open-cell microcellular polystyrene foam and the prepared open-cell microcellular polystyrene foam.

### BACKGROUND OF THE INVENTION

Polymeric foam has been widely used as heat insulation material for the fields where an insulation of thermal transmission is required due to its characteristics of heat insulation and light mass. Moreover, since the process for forming polymeric foam is simple, its production cost for formulation design is reduced.

Basically, the structure of polymeric foam is classified into close- and open-cell structures. The close-cell structure is a structure that most of the cells are each independent and is not communicated with each other while the open-cell structure is a structure that there is no wall between cells and most of the cell is communicated with each other to form channels therein. As to the conventional polystyrene foam used in insulating of heat transmission, to reduce the heat convection in the foam to attain excellent heat insulation effect, it needs to use a low heat transmitting foaming gas during its foaming procedure and form close-cell foam structure. It thus can reduce the heat transmission attributed to collision between the gas molecules since the foaming gas is restricted in the individual cell in the foam. However, since the close-cell foam contains the foaming gas in the foam body, the foam is not vacuumed unless destroying the close-cell structure, so that it is difficult to further improve its heat insulating effect and could not be used in vacuum system. To improve the heat insulating effect of the foam, it should modify its preparing procedures and formulations to obtain foam having improved heat insulating effect.

The process for forming polymeric foam is as follows. The polymeric foaming solution is immersed with foaming gas under high pressure at a temperature higher than the glass transition temperature of the polymer to form a homogeneous system and remain the system under the high pressure. Then the pressure is rapidly released to generate an unstable over-saturated system so that the gas dissolved in the polymeric foaming solution would aggregate into nuclear instantly and separate bubbles out until it attains equilibrium between the bubble pressure and strength of the polymeric material and finally the polymeric solution solidify to obtain polymeric foam. It usually uses carbon dioxide (CO₂) or nitrogen (N₂) gas as the foaming gas. Since homogeneous nucleation requires higher energy and its nucleating sites is few, which results in larger cell size in the resultant foam, it can reduce the nucleating energy by adding nucleating agent to increase the nucleating sites during the foaming process and thus a heterogeneous nucleation for the foaming gas contained in the polymeric solution occurs. Among them, the property of foams is greatly influenced by kinds of the used nucleating agent. Currently, foam is usually formed by extruding-forming process, for example, U.S. Pat. No. 5,674,916 discloses a process for making an extruded, open-cell microcellular polymer foam, which comprises the steps of heating and melting polystyrene; adding a nucleating agent and a foaming agent into the molten polystyrene; blending the mixture into a polymeric foaming solution; extruding and foaming the polymeric foaming solution at an appropriate temperature to form a foam. The foam prepared by the process of U.S. Pat. No. 5,674,916 patent has an open cell content of about 70% or more and has an average cell size of about 70 micrometer or less.

### SUMMARY OF THE INVENTION

One object of the present invention is to provide a process for preparing open-cell microcellular polystyrene foam and the prepared open-cell microcellular polystyrene foam by modifying the process conditions and formulations to obtain open-cell microcellular polystyrene foam having excellent heat insulating effect.

To attain the above object, the process for preparing open-cell microcellular polystyrene foam according to the present invention is characterized by using polyamide polymer which functions both as a nucleating agent and an opening agent to impart the resultant open-cell microcellular polystyrene foam a fine open-cell structure. The process for preparing open-cell microcellular polystyrene foam comprises the steps of blending polystyrene and a polyamide polymer to give a homogeneous mixture; adding a foaming agent into the mixture and blending to give a polymer foaming solution; and extruding and foaming the polymer foaming solution in an extruder.

Since the configuration of the polyamide particle becomes long and thin after blending, it is helpful to the passage of foaming gas and increases the anisotropy of the cells in the resultant foam. Furthermore, since the processing and shaping temperature of the polyamide is higher than the extruding and foaming temperature of the polystyrene foaming solution, if the foaming solution is subjected to extrusion and foaming, the temperature of the extruder is controlled below 170° C., the polyamide polymer is kept in a solid state during the extruding and foaming and thus improves its nucleating and cell-opening functions accordingly.

Moreover, in the subsequent solidification, since the cells in the open-cell microcellular polystyrene foam will break and thus the supporting force attributed by the cell wall will lose, if the polystyrene foam is not solidified in time, the foam would burst or collapse due to the pressure generated in the foaming procedure. Since the solidification is greatly correlated with the viscoelasticity of the formulation of a foaming solution, the polyamide particles can increase the viscosity of the foaming solution to facilitate the solidification and improve the mechanical strength of the resultant foam.

According to the above process, the present invention also provides an open-cell microcellular polystyrene foam prepared by the process. The open-cell microcellular polystyrene foam is characterized by that it is prepared by using polyamide polymer as a nucleating agent during the extruding and foaming procedure. Moreover, the open-cell microcellular polystyrene foam is characterized by having an average open cell content of 60% or more, an average cell size of about 60 micrometer or less, and a density of from 40 to 100 kg/m³.

### BRIEF DESCRIPTION OF DRAWINGS

The present invention is illustrated more detail by reference to the accompanying drawings, wherein:

FIG. 1 shows the flow chart of one preferred embodiment of the process for preparing open-cell microcellular polystyrene foam according to the present invention.

### DETAILED DESCRIPTION OF THE INVENTION

The present invention is illustrated in more detail by reference the following preferred embodiments which are only used for illustration without limiting the scope of the present invention.

According to the process for preparing open-cell microcellular polystyrene foam and the prepared polystyrene foam, the heat insulating effect of the open-cell microcellular polystyrene foam is improved by modifying the process conditions and formulations.

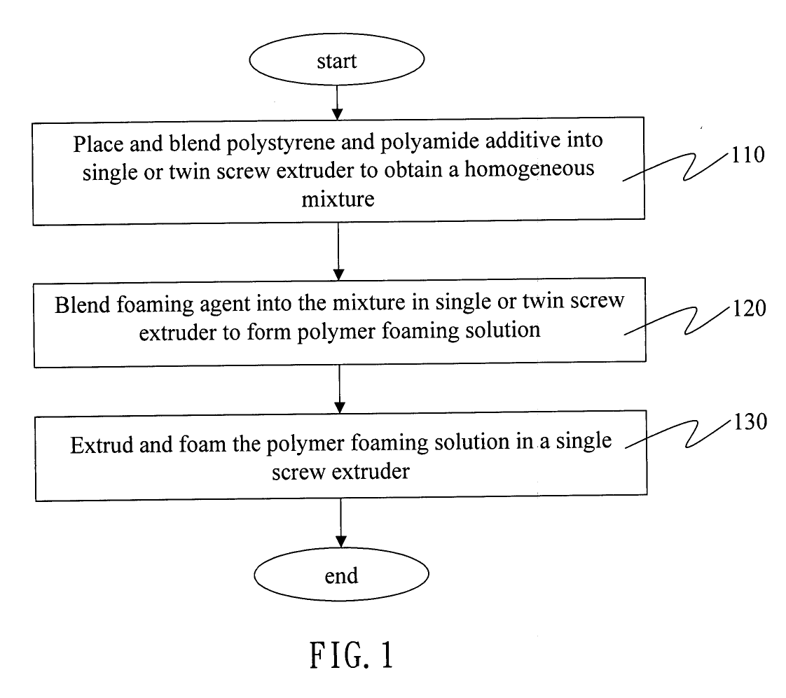

The present process for preparing open-cell microcellular polystyrene foam, referred to FIG. 1 showing the flow chart of one preferred embodiment of the present process, comprises the following steps. First, polystyrene and a polyamide polymer additive are placed and blended in a single screw or a twin screw extruder to give a homogeneous mixture (Step 110); then a foaming agent is mixed with the homogeneous mixture in a single screw or a twin screw extruder to form a polymer foaming solution (Step 120); finally, the polymer foaming solution is extruded and foamed in a single screw extruder (Step 130).

Among them, blending the polystyrene and the polyamide polymer into a homogeneous mixture is operated at a temperature of from 170 to 280° C., preferably of from 190 to 230° C. In extruding and foaming the polymer foaming solution, the temperature of the polymer foaming solution is maintained in a range of from 120 to 150° C., preferably of from 125 to 140° C. Moreover, the blending of polystyrene and polyamide polymer is conducted in an extruder, preferably in a twin screw extruder. Extruding and foaming of the polymer foaming solution is preferably conducted in a single screw extruder.

The polyamide polymer additive is added in an amount of from 0.5 to 5.3% by weight, preferably of from 2.5 to 4.0% by weight, based on the total weight of the mixture. Examples of the polyamide polymer additive include (but not limit to) polycaprolactam, polyundecanoamide, polyhexamethylene azelamide, polyhexamethylene adipamide, and polylauryllactam, with preferably polycaprolactam and polylauryllactam. The foaming agent is added in an amount of from 2.0 to 7.0% by weight, preferably of from 4.0 to 6.2% by weight, based on the total weight of the polymer foaming solution. The foaming agent could be a foaming agent serving through a physically foaming, which examples include pentafluoroethane, trifluoromethane, chlorodifluoromethane, tetrafluoroethane, carbon dioxide, and a mixture of difluoromethane and pentafluoroethanein a weight ratio of 1:1.

Four embodiments by using different polyamide polymer additive and foaming agent at various contents were presented to illustrate the present process in more detail. The detailed formulations and procedures for the embodiments are as follows.

The first embodiment used a mixture of difluoromethane and pentafluoroethanein a weight ratio of 1:1 as the foaming agent. A polyamide polymer additive was added into polystyrene to form a homogeneous mixture. The polyamide polymer additive was added in an amount of 2.5% by weight based on the total weight of the mixture. Then the resultant mixture was blended thoroughly in a twin screw extruder. Foaming agent was added and blended into the mixture at various ratios in a twin screw extruder to give four polymer foaming solutions each having different amount of the foaming agent. Then the resultant polymer foaming solutions were maintained at a temperature of from 126 to 135° C. and extruded and foamed in a single screw extruder to form polystyrene foams. The resultant polystyrene foams were measured their average cell size and average open cell content and listed in following Table 1 along with the content of the foaming agent. The content of the foaming agent is based on the total weight of the polymer foaming solution.

TABLE 1
Additive: Polyamide

| Content of foaming agent | Average cell size | Open-cell content |
|---|---|---|
| (wt %) | (μm) | (%) |
| 4.7 | 29 | 93 |
| 5.3 | 23 | 95 |
| 5.7 | 29 | 93 |
| 5.9 | 24 | 93 |

The second embodiment used polylauryllactam as the polyamide polymer additive and used a mixture of difluoromethane and pentafluoroethanein a weight ratio of 1:1 as the foaming agent. Polyamide polymer additive was added into polystyrene to form a homogeneous mixture. The polyamide polymer additive was added in an amount of 3.0% by weight based on the total weight of the mixture. Then the resultant mixture was blended thoroughly in a twin screw extruder. Foaming agent was added and blended into the mixture at various ratios in a twin screw extruder to give four polymer foaming solutions each having different amount of the foaming agent. Then the resultant polymer foaming solutions were maintained at a temperature of from 126 to 135° C. and extruded and foamed in a single screw extruder to form polystyrene foams. The resultant polystyrene foams were measured their average cell size and average open cell content and listed in following Table 2 along with the content of the foaming agent. The content of the foaming agent is based on the total weight of the polymer foaming solution.

TABLE 2
Additive: polylauryllactam

| Content of foaming agent | Average cell size | Open-cell content |
|---|---|---|
| (wt %) | (μm) | (%) |
| 5.3 | 34 | 93 |
| 5.6 | 23 | 95 |
| 5.8 | 28 | 94 |
| 6.1 | 39 | 95 |

The third embodiment used polycaprolactam as the polyamide polymer additive and used a mixture of difluoromethane and pentafluoroethanein a weight ratio of 1:1 as the foaming agent. Polyamide polymer additive was added into polystyrene to form a homogeneous mixture. The polyamide polymer additive was added in an amount of 3.5% by weight based on the total weight of the mixture. Then the resultant mixture was blended thoroughly in a twin screw extruder. Foaming agent was added and blended into the mixture at various ratios in a twin screw extruder to give five polymer foaming solutions each having different amount of the foaming agent. Then the resultant polymer foaming solutions were maintained at a temperature of from 128 to 134° C. and extruded and foamed in a single screw extruder to form polystyrene foams. The resultant polystyrene foams were measured their average cell size and average open cell content and listed in following Table 3 along with the content of the foaming agent. The content of the foaming agent is based on the total weight of the polymer foaming solution.

TABLE 3
Additive: polycaprolactam

| Content of foaming agent | Average cell size | Open-cell content |
|---|---|---|
| (wt %) | (μm) | (%) |
| 5.7 | 16 | 96 |
| 5.4 | 19 | 93 |
| 5.2 | 24 | 94 |
| 6.0 | 14 | 94 |
| 6.3 | 25 | 94 |

The fourth embodiment used polycaprolactam as the polyamide polymer additive and used carbon dioxide as the foaming agent. Polyamide polymer additive was added into polystyrene to form a homogeneous mixture. The polyamide polymer additive was added in an amount of 3.2% by weight based on the total weight of the mixture. Then the resultant mixture was blended thoroughly in a twin screw extruder. Foaming agent was added and blended into the mixture at various ratios in a twin screw extruder to give three polymer foaming solutions each having different amount of the foaming agent. Then the resultant polymer foaming solutions were maintained at a temperature of from 126 to 135° C. and extruded and foamed in a single screw extruder to form polystyrene foams. The resultant polystyrene foams were measured their average cell size and average open cell content and listed in following Table 4 along with the content of the foaming agent. The content of the foaming agent is based on the total weight of the polymer foaming solution.

TABLE 4
Additive: polycaprolactam

| Content of foaming agent | Average cell size | Open-cell content |
|---|---|---|
| (wt %) | (μm) | (%) |
| 4.4 | 32 | 94 |
| 6.4 | 35 | 95 |
| 4.5 | 52 | 92 |

From the above Tables 1-4, it shows that the present process can produce open-cell microcellular polystyrene foam having fine cell diameter and high open-cell content.

While the present invention has been particularly shown and described by reference to exemplary embodiments thereof, it will be understood by those of ordinary skill in the art that various changes and modifications may be made therein without departing from the spirit and scope of the present invention as defined by the following claims.

What is claimed is:

1. A process for preparing open-cell microcellular polystyrene foam, which comprises the steps of:
blending polystyrene and a polyamide polymer to give a homogeneous mixture;
adding foaming agent into the mixture and blending to give a polymer foaming solution; and
extruding and foaming the polymer foaming solution in an extruder.

2. The process for preparing open-cell microcellular polystyrene foam according to claim 1, wherein the blending of the polystyrene and the polyamide polymer is carried out at a temperature of from 170 to 280° C., preferably at a temperature of from 190 to 230° C.

3. The process for preparing open-cell microcellular polystyrene foam according to claim 1, wherein the blending of the polystyrene and the polyamide polymer is carried out in the extruder.

4. The process for preparing open-cell microcellular polystyrene foam according to claim 1, wherein the blending of the polystyrene and the polyamide polymer is carried out in a separate extruder and the extruder is a single screw extruder or a twin screw extruder.

5. The process for preparing open-cell microcellular polystyrene foam according to claim 1, wherein the extruder is a single screw extruder for extruding and foaming the polymer foaming solution.

6. The process for preparing open-cell microcellular polystyrene foam according to claim 1, wherein the extruding and foaming the polymer foaming solution is carried out at a temperature of from 120 to 150° C., preferably at a temperature of from 125 to 140° C.

7. The process for preparing open-cell microcellular polystyrene foam according to claim 1, wherein the polyamide polymer is present in an amount of from 0.5 to 5.3% by weight, preferably from 2.5 to 4.0% by weight, based on the total weight of the mixture.

8. The process for preparing open-cell microcellular polystyrene foam according to claim 1, wherein the polyamide polymer is at least one selected from the group consisting of polycaprolactam, polyundecanoamide, polyhexamethylene azelamide, polyhexamethylene adipamide, and polylauryllactam.

9. The process for preparing open-cell microcellular polystyrene foam according to claim 1, wherein the foaming agent is present in the polymer foaming solution in an amount of from 2.0 to 7.0% by weight, preferably from 4.0 to 6.2% by weight, based on the total weight of the polymer foaming solution.

10. The process for preparing open-cell microcellular polystyrene foam according to claim 1, wherein the foaming agent is at least one selected from the group consisting of pentafluoroethane, trifluoromethane, chlorodifluoromethane, tetrafluoroethane, carbon dioxide, and a mixture of difluoromethane and pentaethane in a weight ratio of 1:1.

11. An open-cell microcellular polystyrene foam, which is produced by an extruding forming process through the use of a polyamide polymer as a nucleating agent, the open-cell microcellular polystyrene foam is characterized by having an average open cell content of not less than 60% and an average cell size of not more than 60 μm.

12. The open-cell microcellular polystyrene foam according to claim 11, wherein the polyamide polymer is present in an amount of from 0.5 to 5.3% by weight, preferably from 2.5 to 4.0% by weight, based on the total weight of the mixture.

13. The open-cell microcellular polystyrene foam according to claim 11, wherein the polyamide polymer is at least one selected from the group consisting of polycaprolactam, polyundecanoamide, polyhexamethylene azelamide, polyhexamethylene adipamide and polylauryllactam.

14. The open-cell microcellular polystyrene foam according to claim 11, which has a density of from 40 to 100 kg/m³.
